(19) United States
(12) Patent Application Publication
(10) Pub. No.: US 2011/0138977 A1
(43) Pub. Date: Jun. 16, 2011

(54) PORTIONING DEVICE

(75) Inventor: Runar Birgisson, Reykjavik (IS)

(73) Assignee: Marel HF, Gardabaer (IS)

(21) Appl. No.: 11/663,046

(22) PCT Filed: Sep. 16, 2005
(86) PCT No.: PCT/IS2005/000021

§ 371 Date: Nov. 8, 2007

(30) Foreign Application Priority Data
Sep. 16, 2004 (IS) 7455

(51) Int. Cl. B26D 7/30

(52) U.S. Cl. 83/13; 83/77; 83/74

(57) ABSTRACT

The invention provides a method and a device for portioning a substance, e.g. dough for making bread or pastry. The device operates on an elongated body of the substance and separates pieces there from in accordance with an image received from an image generating camera. Accordingly, portioning of the dough occurs without having to compress the dough into a measuring chamber as it is required in traditional portioning of dough.

The invention relates to a processing device provided with extrusion means for extruding an elongated body, e.g. a body of dough, a body of pasta, a body of meat or a body of a similar food product onto a conveyor. The device further comprises processing means for determining portions of the body, and cutting means for separating portions from the body. In particular, the invention relates to a device wherein the portions are formed based on a portioning criterion e.g. for the weight of each portion. The invention could be applied e.g. for processing dough for making bread or cakes in a bakery.

### BACKGROUND OF THE INVENTION

In certain food processing industries, pasty substances are sometimes prepared in large batches from which smaller portions are separated for further processing or for packing. Examples of such products are ground beef and similar minced and mixed substances e.g. for sausages, chicken nuggets etc or dough for making bread or cakes.

In mass production, the substance is sometimes portioned in portioning cylinders from which a fixed volume is extruded by a piston. Each piston stroke extrudes a fixed volume of the substance, and a high production rate can be established in a simple and reliable way. The method, however, has some drawbacks. Some substances are compressible, and the extrusion may therefore change the density and possibly reduce the quality of the substance. Other substances are more elastically compressible, and after the extrusion, the volume of the portion depends on the degree of re-expansion which degree is not necessarily constant over time. An example of such a compressible substance is dough. In order to generate carbon dioxide by fermenting sugars, yeast is often added to the dough. When the carbon dioxide expands, it forms millions of air bubbles and due to the mechanical activity of kneading, gluten which is the protein part of the wheat berry becomes elastic and capable of retaining the bubbles in tiny pockets in the dough whereby the dough rises and becomes elastically compressible.

In other automatic processing systems, portions are separated by a rotating knife or similar cutting means. In such systems, the volume of each formed portion is typically established by conveying the substance in a tube or in a mould whereby the cross-section of the body is maintained until the portion is separated. This again implies other disadvantages, e.g. with respect to the flexibility of the system, in particular with regards to the shape of the cross-section which shape is determined by the specific shape of the tube or mould. Moreover, the maintenance of a fixed cross sectional shape is often inconvenient e.g. in connection with dough which is typically rising due to the fermentation process.

Whether they are based on extrusion from a cylinder or whether they are based on cutting a body with a fixed cross-sectional shape, the existing system are generally designed to form portions of a fixed volume, and in some cases, the weight rather than the volume is important. Again, this is typically the case in producing bread or cakes from dough wherein the density may change over time, e.g. depending upon the quality of the gluten or yeast.

### DESCRIPTION OF THE INVENTION

It is an object of the invention to facilitate continuous portioning of pasty substances such as dough, and in particular to facilitate forming of portions of a specific weight. Accordingly, the invention in a first aspect provides a device for portioning, said device comprising:
a storage device for storing a substance and comprising a discharger for discharging onto an inlet area of a conveyor, an elongated body of substance contained therein,
a conveyor for conveying the body in a downstream direction towards an outlet area, the body being conveyed at a conveying speed,
image generating means for generating an image of a portion of the body, and
processing means adapted to communicate with the image generating means to receive the image of the body, and based on the image and a portioning criteria, to generate a cutting signal for cutting means arranged along the conveyor to cut the body and thus to form a portion thereof.

Since the substance is discharged in the form of one continuous elongated body from which portions are subsequently separated based on an image of the substance, portioning can be carried out in accordance with a specific criteria for the weight, size or even shape of the portion irrespective the size or shape of the body. As an example, the portioning could be carried out on bodies which are carried on the conveyor without being limited to a specific cross-sectional shape, and thus without any compression of the substance. Moreover, the amount of the substance in each portion can become more uniform since re-expansion can be avoided.

In one embodiment, the storage device could be a kneading, mixing or mincing trough for processing meat, dough or similar food substances. The storage device could be located above a conveyor belt of the conveyor. The storage device may have an opening in the bottom through which the substance is ejected onto the belt in one long endless stream.

Sometimes, it is an advantage after the kneading, mixing or mincing, to allow the substance to settle prior to the cutting. During such a settling time, various processes may take place. If the substance is dough, this settling time could be used for rising the dough. Since the process is preferably carried out as a continuous process, the time could be established by making the conveyor relatively long. To save space, the conveyor may form a path with a plurality of turns or even loops in a vertical plane thereby forming a number of parallel and vertically disposed layers of the elongated body conveyed thereon. For that purpose, the conveyor may comprise a plurality of independently operated conveyor belt segments. Each segment could form one of the above mentioned layers. In order to convey the body from one superjacent belt to a subjacent belt, the subjacent belt could be offset slightly in the conveying direction of the superjacent belt. When a part of the body reaches the end of the superjacent belt it falls down onto the subjacent belt on which it is conveyed in a direction which is opposite the direction of the superjacent belt. When it reaches the end of the subjacent belt, the procedure continues with the next belt arranged bellow the subjacent belt and offset in the conveying direction of the subjacent belt. In one single pile of such conveyor belts, a very long continuous body can be conveyed alternating in one direction and in an opposite direction whereby a relatively long fermentation time can be facilitated in spite of a constantly moving conveyor. Due to the rise of dough, the length of the body may increase over time. For that reason, each of the segments may run with different conveying speeds so that the speed increases from a first segment towards a last segment.

The image generating means could comprise a camera and an image processor. The camera could be a digital camera with a CCD to generate a matrix of pixel values or the camera could be a line-scan camera, e.g. based on a laser beam or a lacer curtain and a single array CCD to generate an array of pixel values. The image generating means could even have more cameras located to capture pictures of different areas of the body, or the image generating means may comprise mirrors arranged to reflect an image e.g. of a side-surface of the body into a camera located above an upper-surface of the body. The image generating means may in particular be adapted to generate a plurality of 2-dimensional images of a cross-sectional shape of the body while the body is conveyed past the camera and from these 2-dimensional images to form a 3-dimensional image of a portion of the body, e.g. by interpolation between the 2-dimensional images.

The device could be provided with a computer communicating with the image generating means to receive the image of a portion of the body, and based on the image and a portioning criteria, to generate a cutting signal for cutting means arranged along the conveyor to cut the body and thus to form a portion. The cutting means could be a conventional blade knife, a rotary circular knife, a water-jet nozzle etc. Preferably, the knife is adapted to follow the movement of the conveyor to cut a straight-line cut across the body, e.g. perpendicular to the longitudinal direction of the body.

The portioning criteria could e.g. relate to the weight of the body or to the shape of the body. As an example, the computer may generate signals to the cutting means to separate portions of a specific length from the body. In a preferred embodiment, however, the computer uses a density quantifier δ and an image of the body to calculate the weight of a part of the body and thereby facilitates forming of portions with equal weight.

Weight detecting means e.g. in the form of a scale may be arranged in the downstream direction after the cutting means to determine the actually achieved weight of the substance portion, and if the computer is adapted to use a density quantifier, the actually achieved weight may be communicated to the computer to enable update of the density quantifier. As an example, the cutting of one portion from the body could be based on a density quantifier δ being 1.5 g/cm³ which by the computer is related to a part of the body which part has a volume of 500 cm³. Using these two figures, the computer arrives at an estimated weight of 750 g. If the weight detecting means subsequently registers a weight of 800 g, the density quantifier δ could be updated to the value of:

$$δ = \frac{800 g}{500 {cm}^{3}} = 1.6 \frac{g}{{cm}^{3}}$$

and in the forming of the subsequent portion, the last calculated density quantifier is used to determine a required volume to achieve a specific weight. In that respect, it is an advantage that the substance is conveyed as one uniform elongated body since changes in the density along the length of the body will result in continuously changing calculated density quantifiers. For that purpose, the computer may be adapted from the calculated density quantifiers, to establish a model indicating the difference in the quantifier for a specific length of the body. In that way, a portion may be formed based on the volume of a part of the body and the density quantifier which quantifier is either increased or decreased based on the model.

If the substance requires a settling time, e.g. due to fermentation or similar processes, the computer may further be adapted to survey this process, e.g. by calculating a degree of rise of the substance, e.g. indicating the volumetric difference between the volume of the substance which is discharged from the storage device and the volume of the substance which passes the image generating means. In a similar manner, the image generating means may be capable of determining a surface characteristic of the body, e.g. a degree of reflection or a colour of the body, and the computer may be adapted to survey this characteristic e.g. to determine if the settling time is sufficient.

Pressing means for pressing the substance e.g. for spreading clumps of yeast in dough or to ensure a specific height of the body may preferably be included in the device, and preferably such a pressing means is located before the first image generation means in the downstream direction, In that way the image is generated directly after the pressing of the body.

To control the settling process, e.g. to evaluate the fermentation of dough, further image generating means may be located in the downstream direction after the portioning means to generate an image of the substance portions individually. In fact, a plurality of image generating means could be arranged to generate images of the substance along the conveyor, and by comparing images from different image generating means, the process can be surveyed, e.g. by calculating a rise pr. time unit quantifier indicating an increase in volume pr. time unit.

In a second aspect, the invention provides a method for portioning a substance, said method comprising the steps of discharging an elongated body onto a conveyor, conveying the body in a downstream direction at a conveying speed, generating an image of the body, and processing the image to generate a cutting signal for cutting means to cut a portion out of the body when a predetermined volume of the body has passed the cutting means in the downstream direction. The method may further comprise the steps of weighing the portion by weighing means, and from the weight of the portion and the image, generating a relationship between the volume and the weight of the body and optionally a degree of rise of the substance. The method may further comprise any step necessary to provide the features described in relation to the first aspect of the invention.

### DETAILED DESCRIPTION

In the following, the invention will be described in further details with reference to the drawing in which:

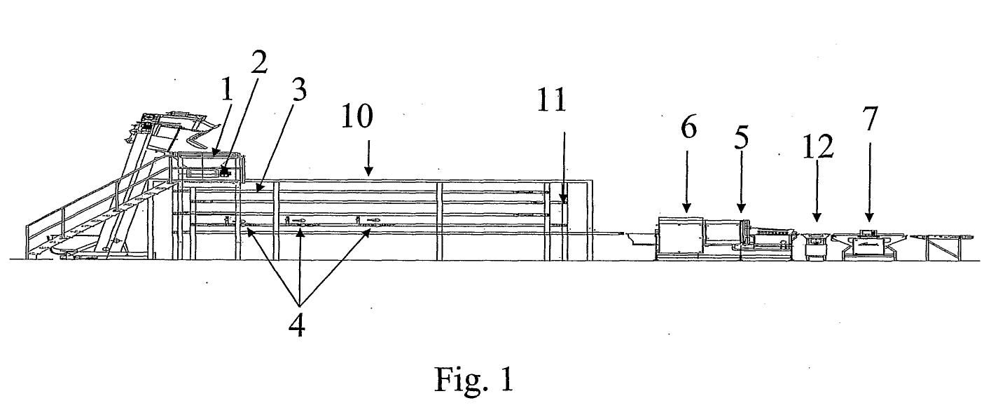

FIG. 1 shows a device according to the invention, and specifically adapted for processing dough for making bread or cakes.

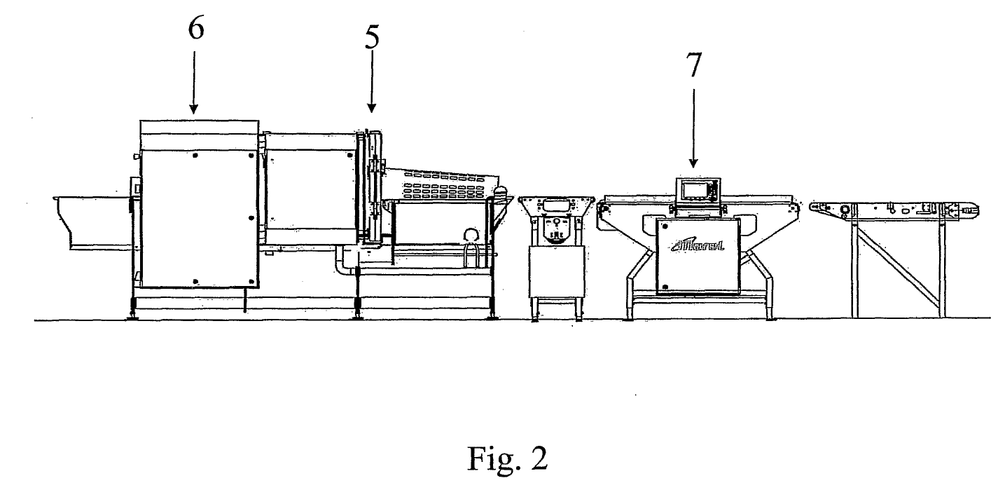

FIG. 2 shows a device according to the invention were CCD camera (6) generates volumetric image of the dough,

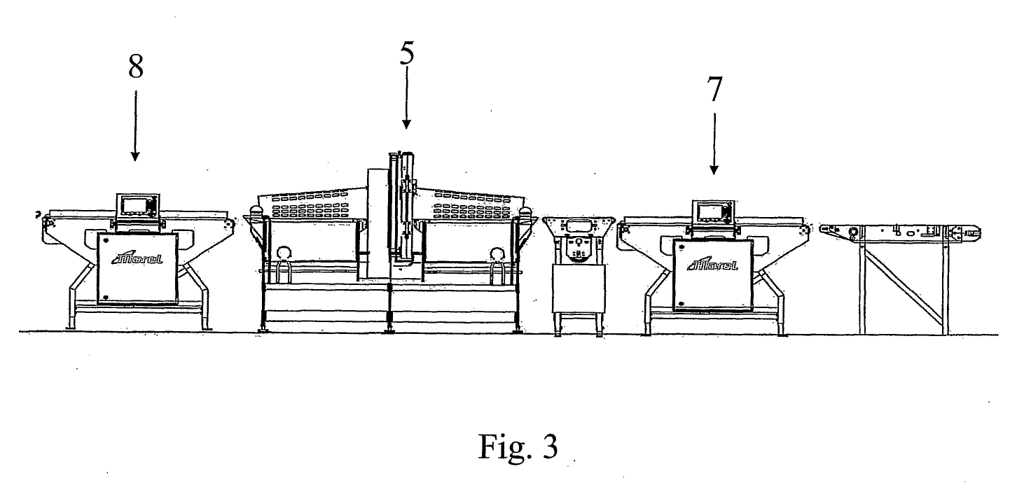

FIG. 3 shows a device according to the invention were a dynamic scale (8) is used to approximate the weight of the dough,

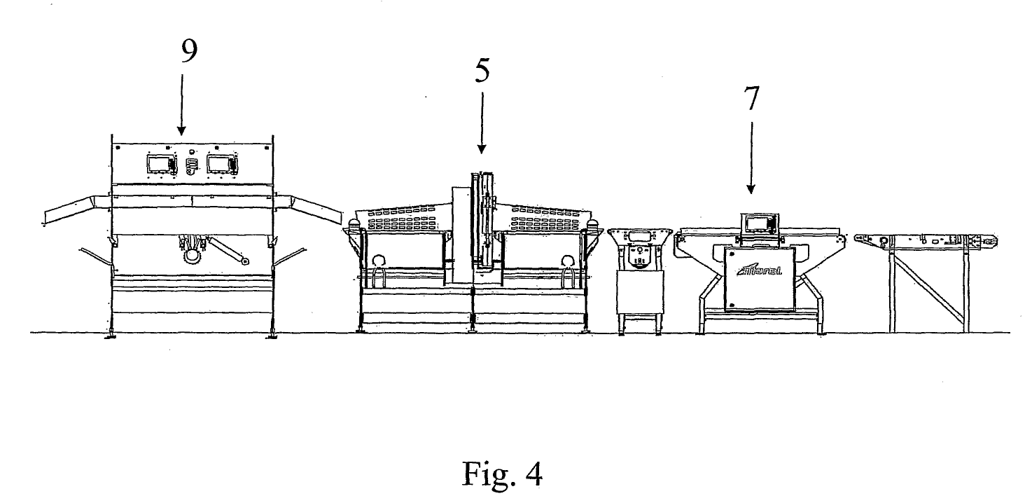

FIG. 4 shows a device according to the invention were X-Ray imager (9) is used to estimate the density of the dough.

The dough-processing device shown in FIG. 1 comprises a frame 10, dough storage and kneading device 1 with discharger 2 fastened to the frame. Attached to the frame is multiple endless conveying belts running on variable conveying speed. The conveyors are organized in overlapping stacked fashion and transport the dough from the discharger to the portioning device 5. The first belt 3 receives the dough from the discharger and releases it by means of gravity onto the overlapping portion of the next belt 11 positioned directly underneath the first belt. While the dough is transported it expands in all directions and to compensate for the expansion in the longitudinal direction, each successive belt runs at higher speed. Rollers 4 are attached to the frame 10 to facilitate the fermentation of the yeast by pressing the dough and to form the dough into desirable shape. The first two sets of rollers press the air out of the dough and thus facilitate the fermentation of the residual yeast. The last set of rollers is used to form the final shape of the dough and to press a surface image onto the dough before it is baked.

The fermentation is controlled by heating elements (not shown in the drawings) located in the conveyor belts. Moreover, the heating elements in each conveyor can be controlled independently.

The last conveyor in the stack leads to a volumetric weighing device 6 and dough portioning device 5. The volumetric weighing device 6 uses a CCD camera and laser curtain to generate a three dimensional image of the elongated dough just before it enters the portioning device. The portioning device communicates with the imaging device and generates a cutting signal based on the image and a portioning criteria to cut the dough body and thus to form a dough portion. Finally, the dough portion is transported by conveyor 12 to a weighting device 7.

The weighing device also communicates with the portioning device to provide error-correcting signal based on the actual weight of the dough portion. Therefore, the dough length is constantly adjusted to maintain a consistent dough weight throughout the batch being processed. The weight control is based on a known density quantifier δ whose value depends on the kind of bread being processed. The volume of the dough provided by the volumetric weighting device, and a small constant epsilon (ε).

weight=volume×δ+ε

The cutting control algorithm uses this information to calculate the length of each dough portion. The constant ε is calculated from the actual weight of the last dough portion weighted.

1. A device for forming portions of a substance, said device comprising:
a discharger for discharging an elongated body of the substance onto an inlet area of a conveyor,
a conveyor for conveying the body in a downstream direction at a conveying speed towards an outlet area,
image generating means for generating an image of a portion of the body, and
processing means adapted to communicate with the image generating means to receive the image of the body, and based on the image and a portioning criteria, to generate a cutting signal for cutting means arranged along the conveyor to separate the portions from the body.

2. A device according to claim 1, wherein the criteria relates to at least one of a weight of the body and the shape of the body.

3. A device according to claim 2, further comprising weight detecting means arranged in the downstream direction after the cutting means to determine a weight of the portion.

4. A device according to claim 3, wherein the processing means communicates with the weight detecting means to receive a weight signal representing the weight of the portion.

5. A device according to claim 4, wherein the processing means is adapted from the weight signal to generate or update a density identifier representing a relationship between the image of a portion of the body and the weight of the portion of the body.

6. A device according to claim 1, wherein the conveyor is adapted to increase the conveying speed from the inlet area to the outlet area.

7. A device according to claim 1, wherein the conveyor comprises at least a first and a second conveying section moving at different conveying speeds.

8. A device according to claim 7, wherein the first conveying section is located superjacent to the second conveying section.

9. A device according to claim 8, wherein the first conveying section conveys the body in a first direction, and wherein the second conveying section conveys the body in a second, opposite direction.

10. A device according to claim 6, adapted for conveying a body made of dough which is rising during the conveying, and wherein the increase in the conveying speed from the inlet to the outlet is adapted to compensate for an elongation of the body caused by the rising of the dough.

11. A device according to claim 1, adapted for conveying a body made of meat.

12. A device according to claim 1, adapted for conveying a body made of pasta.

13. A device according to claim 1, adapted for conveying a body made of fish.

14. A method for forming portions of a substance, said method comprising the steps of:
discharging an elongated body of the substance onto a conveyor,
conveying the body in a downstream direction at a conveying speed,
generating an image of a portion of the body, and
generating a cutting signal for cutting means to cut a portion out of the body, the cutting signal being generated based on the image.

15. A method according to claim 14, further comprising the steps of:
weighing the portion by weighing means, and
generating a relationship between the image of the portion and the weight of the portion.
